(19) United States
(12) Patent Application Publication
(10) Pub. No.: US 2023/0004909 A1
(43) Pub. Date: Jan. 5, 2023

(54) SYSTEMS AND METHODS FOR PROCESSING EXPERIMENTAL REQUESTS AT REMOTE LABORATORIES

(71) Applicant: STRATEOS, INC., Menlo Park, CA (US)

(72) Inventors: Sayagoud Ramu Phanimukla, Pleasanton, CA (US); Abhishek Kumar, Dublin, CA (US); Rickin Pankaj Patel, Elk Grove, CA (US)

(21) Appl. No.: 17/854,715

(22) Filed: Jun. 30, 2022

Related U.S. Application Data
(60) Provisional application No. 63/218,272, filed on Jul. 2, 2021.

(51) Int. Cl. G06Q 10/06

(52) U.S. Cl. CPC G06Q 10/06316

(57) ABSTRACT

System and method for processing an experimental request. For example, the method includes generating a set of instructions for performing experiments related to the experimental request, determining a plurality of sequence schedules for completing the set of instructions, receiving an indication of a sequence schedule selected from the plurality of sequence schedules, and transmitting commands to execute the set of instructions according to the selected sequence schedule.

### CROSS-REFERENCE TO RELATED APPLICATIONS

This application claims priority to U.S. Provisional Patent Application No. 63/218,272, filed Jul. 2, 2021, which is incorporated by reference herein for all purposes.

The following four applications, including this one, are being filed concurrently and the other applications are hereby incorporated by reference in their entirety for all purposes:

1. U.S. patent application Ser. No. ______, titled “Systems and Methods for Processing Experimental Workflows at Remote Laboratories” (Attorney Docket Number 520295.000014); and

2. U.S. patent application Ser. No. ______, titled “Systems and Methods for Managing Experimental Requests at Remote Laboratories” (Attorney Docket Number 520295.000015).

3. U.S. patent application Ser. No. ______, titled “Systems and Methods for Processing Experimental Requests at Remote Laboratories” (Attorney Docket Number 520295.000016).

4. U.S. patent application Ser. No. ______, titled “Systems and Methods for Performing Experiments at Remote Laboratories” (Attorney Docket Number 520295.000017).

### FIELD OF THE DISCLOSURE

Some embodiments of the present disclosure are directed to processing experimental requests. More particularly, certain embodiments of the present disclosure provide systems and methods for generating instructions for an experimental request. Merely by way of example, the present disclosure has been applied to executing the experimental request based upon the generated instructions. But it would be recognized that the present disclosure has much broader range of applicability.

### BACKGROUND OF THE DISCLOSURE

Experiments performed at designated laboratories are limited by existing infrastructure. Remote laboratories, on the other hand, provide the opportunity to carry out different experiments with different scope at the same time. Accordingly, there exists a need to develop techniques that can enable users to scale to remote laboratory infrastructures when needing capability and/or capacity.

### BRIEF SUMMARY OF THE DISCLOSURE

Some embodiments of the present disclosure are directed to processing experimental requests. More particularly, certain embodiments of the present disclosure provide systems and methods for generating instructions for an experimental request. Merely by way of example, the present disclosure has been applied to executing the experimental request based upon the generated instructions. But it would be recognized that the present disclosure has much broader range of applicability.

According to certain embodiments, a method for processing an experimental request includes generating a set of instructions for performing one or more experiments related to the experimental request. Also, the method includes determining a plurality of sequence schedules for completing the set of instructions. Further, the method includes receiving an indication of a sequence schedule selected from the plurality of sequence schedules. Moreover, the method includes transmitting one or more commands to execute the set of instructions according to the selected sequence schedule.

According to some embodiments, a system for processing an experimental request includes one or more processors and a memory storing instructions for execution by the one or more processors. The instructions, when executed by the one or more processors, cause the system to generate a set of instructions for performing one or more experiments related to the experimental request. Also, the instructions, when executed by the one or more processors, cause the system to determine a plurality of sequence schedules for completing the set of instructions. Further, the instructions, when executed by the one or more processors, cause the system to receive an indication of a sequence schedule selected from the plurality of sequence schedules. Moreover, the instructions, when executed by the one or more processors, cause the system to transmit one or more commands to execute the set of instructions according to the selected sequence schedule.

According to certain embodiments, a non-transitory computer-readable medium stores instructions for processing an experimental request. The instructions are executed by one or more processors of a computing device. The non-transitory computer-readable medium includes instructions to generate a set of instructions for performing one or more experiments related to the experimental request. Also, the non-transitory computer-readable medium includes instructions to determine a plurality of sequence schedules for completing the set of instructions. Further, the non-transitory computer-readable medium includes instructions to receive an indication of a sequence schedule selected from the plurality of sequence schedules. Moreover, the non-transitory computer-readable medium includes instructions to transmit one or more commands to execute the set of instructions according to the selected sequence schedule.

Depending upon the embodiment, one or more benefits may be achieved. These benefits and various additional objects, features and advantages of the present disclosure can be fully appreciated with reference to the detailed description and accompanying drawings that follow.

### BRIEF DESCRIPTION OF THE DRAWINGS

FIG. 1 shows a simplified method for processing experimental requests according to certain embodiments of the present disclosure.

FIG. 2 shows a simplified system for processing experimental requests according to certain embodiments of the present disclosure.

FIG. 3 shows a simplified diagram illustrating various modules for processing experimental requests according to certain embodiments of the present disclosure.

### DETAILED DESCRIPTION OF THE DISCLOSURE

Some embodiments of the present disclosure are directed to processing experimental requests. More particularly, certain embodiments of the present disclosure provide systems and methods for generating instructions for an experimental request. Merely by way of example, the present disclosure has been applied to executing the experimental request based upon the generated instructions. But it would be recognized that the present disclosure has much broader range of applicability.

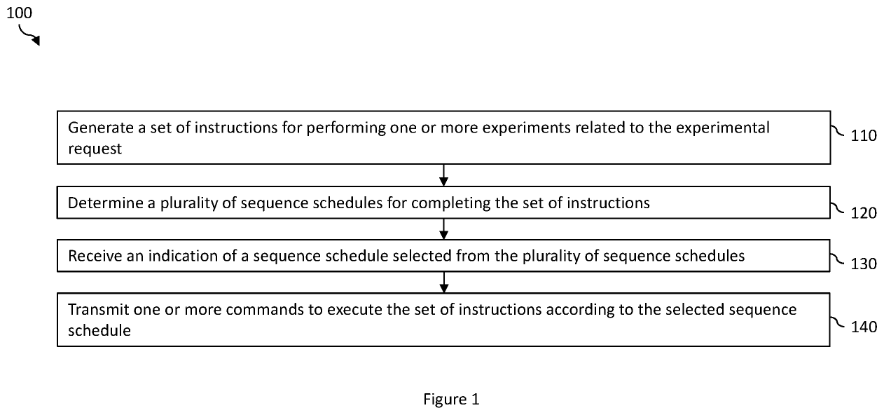

FIG. 1 shows a simplified method for managing experimental requests according to certain embodiments of the present disclosure. This figure is merely an example, which should not unduly limit the scope of the claims. One of ordinary skill in the art would recognize many variations, alternatives, and modifications. The method 100 includes process 110 for generating instructions, process 120 for determining sequence schedules, process 130 for receiving a selected sequence schedule, and process 140 for transmitting commands to execute the instructions. Although the above has been shown using a selected group of processes for the method, there can be many alternatives, modifications, and variations. For example, some of the processes may be expanded and/or combined. Other processes may be inserted to those noted above. Depending upon the embodiment, the sequence of processes may be interchanged with others replaced. For example, some or all processes of the method are performed by a computing device or a processor directed by instructions stored in memory. As an example, some or all processes of the method are performed according to instructions stored in a non-transitory computer-readable medium.

At the process 110, a set of instructions for performing one or more experiments related to an experimental request are generated according to certain embodiments. In some embodiments, the experimental request is received from a submitter and processed to generate the set of instructions.

At the process 120, a plurality of sequence schedules for completing the set of instructions are determined according to certain embodiments. In some embodiments, the plurality of sequence schedules are determined based upon various constraints, such as one or more available devices, one or more available materials, one or more estimated durations of executing the set of instructions, one or more optimizations (e.g., minimum execution time, maximum throughput of instructions, maximum device usage, etc.), and one or more experimental constraints (e.g., biological design constraints). In certain embodiments, an optimal sequence schedule is determined based on the various constraints.

At the process 130, an indication of a sequence schedule selected from the plurality of sequence schedules is received according to certain embodiments. In some embodiments, a desired sequence schedule is selected by the submitter of the experimental request.

At the process 140, one or more commands to execute the set of instructions according to the selected sequence schedule are transmitted according to certain embodiments. In some embodiments, the one or more commands are transmitted to one or more human operators to execute the set of instructions according to the selected sequence schedule. In certain embodiments, the one or more commands are transmitted to one or more robotic operators to execute the set of instructions according to the selected sequence schedule. In some embodiments, the one or more commands are transmitted to one or more human operators and one or more robotic operators to execute the set of instructions according to the selected sequence schedule.

In certain embodiments, information associated with executing the set of instructions according to the selected sequence schedule are collected and transmitted in response to the experimental request. In various embodiments, the collected information includes environmental variables, device statuses, device feedbacks, and/or human feedbacks.

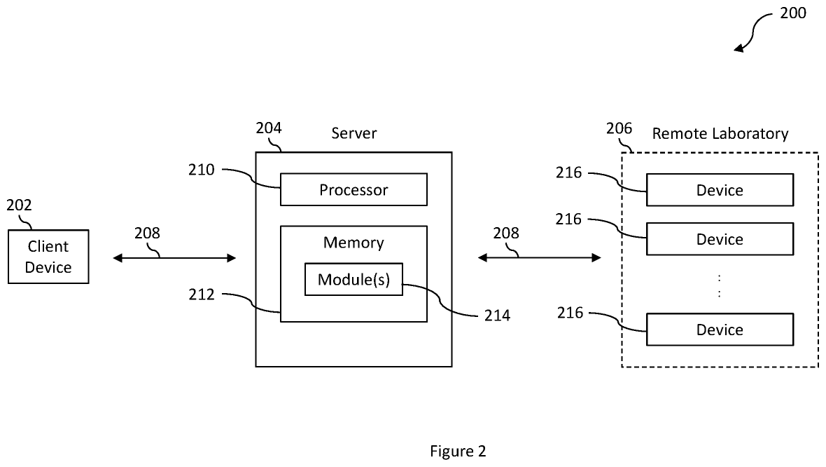

FIG. 2 shows a simplified system for processing experimental requests according to certain embodiments of the present disclosure. This figure is merely an example, which should not unduly limit the scope of the claims. One of ordinary skill in the art would recognize many variations, alternatives, and modifications. The system 200 includes a client device 202, a server 204 and a remote laboratory 206. Although the above has been shown using a selected group of components for the system, there can be many alternatives, modifications, and variations. For example, some of the components may be expanded and/or combined. Other components may be inserted to those noted above. Depending upon the embodiment, the arrangement of components may be interchanged with others replaced.

In various embodiments, the client device 202, the server 204, and the remote laboratory 206 are communicatively coupled to one another via a suitable network 208 (e.g., Internet, mobile communication network, virtual private network, local area network, etc.). In some embodiments, the server 204 is part of or located at the remote laboratory 206. In certain embodiments, multiple remote laboratories 206 exist in the system 200.

In certain embodiments, a user (e.g., a scientist, a researcher, etc.) may use the client device 202 to communicate with the server 204 for processing experimental requests at the remote laboratory 206. For example, the server 204 executes one or more operations to implement the method 100. In some embodiments, the server 204 includes a processor 210 and a memory 212. For example, the processor 210 is configured to execute instructions and/or one or more modules 214 to perform the various operations associated with the method 100. As an example, the instructions and the one or more modules 214 are stored in the memory 212.

In some embodiments, the remote laboratory 206 employs one or more devices 216 to execute the experimental workflow. For example, the one or more devices 216 may include acoustic liquid handlers (e.g., Beckman Echo 650/525, EDC Biosystems ATS), polymerase chain reaction (PCR) machines (e.g., Bio-Rad CFX96, Bio-Rad CFX384, Thermo Fisher 7500 RT), centrifuges (e.g., Bionex HiG 4), reagent dispensers (e.g., Thermo Scientific Multidrop, Formulatrix Tempest), magnetic purification processors (e.g., Thermo Scientific KingFisher Flex Magnetic Particle Processor Magnetic Plate Separation), liquid handling devices (e.g., Agilent Bravo 96w/384w, Tecan ADP, Hamilton Star), flow cytometers (e.g., Attune NxT Acoustic Focusing Cytometer), live cell formats (e.g., cell imaging), Next-generation sequencing (NGS) sequencers (e.g., Pacific Biosciences RS II sequencer, Illumina HiSeq 4000 sequencer), analytical chemistry devices (e.g., Agilent LC/MS Infinity II), and/or synthetic chemistry robotics. In various embodiments, the one or more devices 216 can be combined in any number of ways. In some embodiments, a mix of human and/or robotic laboratory services are provided to manage and process experimental workflows at the remote laboratory 206.

In certain embodiments, the system 200 is employed for various scientific applications and/or research areas (e.g., drug discovery, cancer research, protein engineering, synthetic biology, high throughput screening, bio-chemical assays, medicinal chemistry, personalized medicine, and/or closed-loop machine learning applications).

In various embodiments, any variety of machine learning approaches may be performed on data generated in the system 200 to further inform and guide next steps in experimentation, improve performance, create new experiments, and/or analyze data across previously disparate scientific applications.

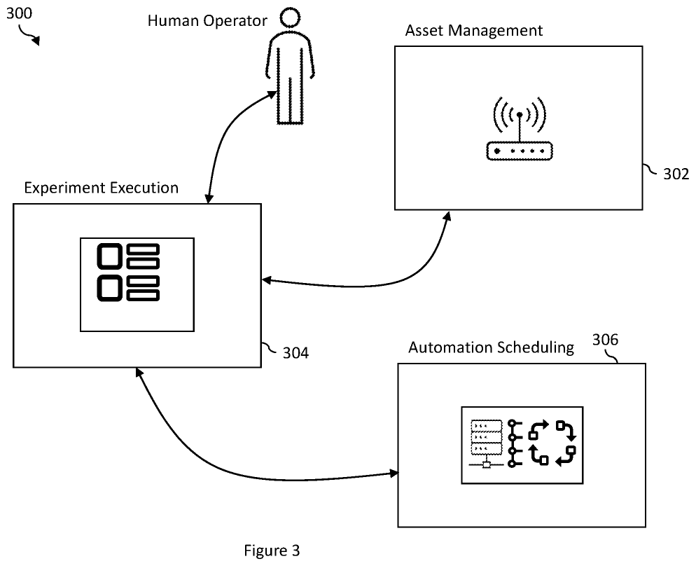

FIG. 3 shows a simplified diagram of various modules for processing experimental requests according to certain embodiments of the present disclosure. This figure is merely an example, which should not unduly limit the scope of the claims. One of ordinary skill in the art would recognize many variations, alternatives, and modifications. The system 300 includes an asset management module 302, an experiment execution module 304, and an automation scheduling module 306. Although the above has been shown using a selected group of components for the system, there can be many alternatives, modifications, and variations. For example, some of the components may be expanded and/or combined. Other components may be inserted to those noted above. Depending upon the embodiment, the arrangement of components may be interchanged with others replaced.

In various embodiments, one or more processes are executed by the modules 302-306 for scheduling, sequencing, optimizing, and/or performing steps in an experimental request executed at one or more remote laboratories.

In certain embodiments, the asset management module 302, the experiment execution module 304, and/or the automation scheduling module 306 are web-based modules. For example, the modules 302-306 are accessible via the Internet. In some embodiments, the modules 302-306 are part of the one or more modules 214 of FIG. 2.

In some embodiments, the asset management module 302 includes functionalities to provide a driver and/or data uploader. In various embodiments, the asset management module 302 is able to control and execute commands on one or more devices and/or create a set of configurable properties (e.g., device configuration) for the one or more devices.

In certain embodiments, the asset management module 302 manages device infrastructure through a suitable interface (e.g., user interface, application programming interface, etc.). For example, the asset management module 302 commissions or provisions one or more devices under an edge node or cloud infrastructure. As an example, the asset management module 302 manages the deployment of a device controller for every device in the edge node or cloud infrastructure. For example, the asset management module 302 commands one or more devices to start, stop, restart, etc.

In some embodiments, the asset management module 302 manages the configurations/settings of a device (e.g., laboratory specific configurations as required by operations or experimental constraints). For example, the asset management module 302 allows a user (e.g., human operator) to view the configurations/settings of the device, and/or edit the configurations/settings of the device. As an example, the configurations/settings of the device are updated to the device in real-time. For example, the configurations/settings of the device are versioned and tracked to leave a configuration audit trail.

In certain embodiments, the asset management module 302 monitors the status of the device. For example, the asset management module 302 allows the user to monitor and view real-time status updates, connection statuses, and/or device health. As an example, the asset management module 302 allows the user to monitor and view real-time updates of the connection status of the device to the device controller.

In some embodiments, the asset management module 302 trains and configures the device remotely. For example, the device may be a robotic device that requires waypoint training (e.g., a Precise Flex robotic arm). As an example, the robotic device can be trained and configured remotely by the asset management module 302. For example, there are no limitations on how many devices can be trained at any given time.

In certain embodiments, the experiment execution module 304 includes functionalities to provide detailed experimental steps. For example, the experiment execution module 304 provides detailed steps for execution by human and/or robotic operators.

In some embodiments, the automation scheduling module 306 includes functionalities that provide device control, task management, and/or task execution. In certain embodiments, the automation scheduling module 306 provides functionalities that enable the user to define scientific constraints from protocols.

According to certain embodiments, a method for processing an experimental request includes generating a set of instructions for performing one or more experiments related to the experimental request. Also, the method includes determining a plurality of sequence schedules for completing the set of instructions. Further, the method includes receiving an indication of a sequence schedule selected from the plurality of sequence schedules. Moreover, the method includes transmitting one or more commands to execute the set of instructions according to the selected sequence schedule. For example, the method is implemented according to at least FIG. 1.

According to some embodiments, a system for processing an experimental request includes one or more processors and a memory storing instructions for execution by the one or more processors. The instructions, when executed by the one or more processors, cause the system to generate a set of instructions for performing one or more experiments related to the experimental request. Also, the instructions, when executed by the one or more processors, cause the system to determine a plurality of sequence schedules for completing the set of instructions. Further, the instructions, when executed by the one or more processors, cause the system to receive an indication of a sequence schedule selected from the plurality of sequence schedules. Moreover, the instructions, when executed by the one or more processors, cause the system to transmit one or more commands to execute the set of instructions according to the selected sequence schedule. For example, the system is implemented according to at least FIG. 2.

According to certain embodiments, a non-transitory computer-readable medium stores instructions for processing an experimental request. The instructions are executed by one or more processors of a computing device. The non-transitory computer-readable medium includes instructions to generate a set of instructions for performing one or more experiments related to the experimental request. Also, the non-transitory computer-readable medium includes instructions to determine a plurality of sequence schedules for completing the set of instructions. Further, the non-transitory computer-readable medium includes instructions to receive an indication of a sequence schedule selected from the plurality of sequence schedules. Moreover, the non-transitory computer-readable medium includes instructions to transmit one or more commands to execute the set of instructions according to the selected sequence schedule. For example, the non-transitory computer-readable medium is implemented according to at least FIG. 1, FIG. 2, and/or FIG. 3.

For example, some or all components of various embodiments of the present disclosure each are, individually and/or in combination with at least another component, implemented using one or more software components, one or more hardware components, and/or one or more combinations of software and hardware components. In another example, some or all components of various embodiments of the present disclosure each are, individually and/or in combination with at least another component, implemented in one or more circuits, such as one or more analog circuits and/or one or more digital circuits. In yet another example, while the embodiments described above refer to particular features, the scope of the present disclosure also includes embodiments having different combinations of features and embodiments that do not include all of the described features. In still another example, various embodiments and/or examples of the present disclosure can be combined.

Additionally, the methods and systems described herein may be implemented on many different types of processing devices by program code comprising program instructions that are executable by the device processing subsystem. The software program instructions may include source code, object code, machine code, or any other stored data that is operable to cause a processing system to perform the methods and operations described herein. Certain implementations may also be used, however, such as firmware or even appropriately designed hardware configured to perform the methods and systems described herein.

The systems' and methods' data (e.g., associations, mappings, data input, data output, intermediate data results, final data results) may be stored and implemented in one or more different types of computer-implemented data stores, such as different types of storage devices and programming constructs (e.g., RAM, ROM, EEPROM, Flash memory, flat files, databases, programming data structures, programming variables, IF-THEN (or similar type) statement constructs, application programming interface). It is noted that data structures describe formats for use in organizing and storing data in databases, programs, memory, or other computer-readable media for use by a computer program.

The systems and methods may be provided on many different types of computer-readable media including computer storage mechanisms (e.g., CD-ROM, diskette, RAM, flash memory, computer's hard drive, DVD) that contain instructions (e.g., software) for use in execution by a processor to perform the methods' operations and implement the systems described herein. The computer components, software modules, functions, data stores and data structures described herein may be connected directly or indirectly to each other in order to allow the flow of data needed for their operations. It is also noted that a module or processor includes a unit of code that performs a software operation, and can be implemented for example as a subroutine unit of code, or as a software function unit of code, or as an object (as in an object-oriented paradigm), or as an applet, or in a computer script language, or as another type of computer code. The software components and/or functionality may be located on a single computer or distributed across multiple computers depending upon the situation at hand.

The computing system can include client devices and servers. A client device and server are generally remote from each other and typically interact through a communication network. The relationship of client device and server arises by virtue of computer programs running on the respective computers and having a client device-server relationship to each other.

This specification contains many specifics for particular embodiments. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations, one or more features from a combination can in some cases be removed from the combination, and a combination may, for example, be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Although specific embodiments of the present disclosure have been described, it will be understood by those of skill in the art that there are other embodiments that are equivalent to the described embodiments. Accordingly, it is to be understood that the present disclosure is not to be limited by the specific illustrated embodiments.

What is claimed is:

1. A method for processing an experimental request, the method comprising:
generating a set of instructions for performing one or more experiments related to the experimental request;
determining a plurality of sequence schedules for completing the set of instructions;
receiving an indication of a sequence schedule selected from the plurality of sequence schedules; and
transmitting one or more commands to execute the set of instructions according to the selected sequence schedule.

2. The method of claim 1, further comprising:
collecting information associated with executing the set of instructions according to the selected sequence schedule; and
transmitting the collected information in response to the experimental request.

3. The method of claim 1, wherein determining the plurality of sequence schedules includes:
determining the plurality of sequence schedules based at least in part upon one or more available devices, one or more available materials, one or more estimated durations of executing the set of instructions, and one or more optimizations.

4. The method of claim 1, wherein transmitting the one or more commands to execute the set of instructions includes:
transmitting, to one or more human operators, the one or more commands to execute the set of instructions according to the selected sequence schedule.

5. The method of claim 1, wherein transmitting the one or more commands to the execute the set of instructions includes:
transmitting, to one or more robotic operators, the one or more commands to execute the set of instructions according to the selected sequence schedule.

6. The method of claim 1, wherein transmitting the one or more commands to the execute the set of instructions includes:
transmitting, to one or more human operators and one or more robotic operators, the one or more commands to execute the set of instructions according to the selected sequence schedule.

7. The method of claim 2, wherein the collected information includes at least one selected from a group consisting of an environmental variable, a device status, a device feedback, and a human feedback.

8. A system for processing an experimental request, the system comprising:
one or more processors; and
a memory storing instructions that, when executed by the one or more processors, cause the system to:
generate a set of instructions for performing one or more experiments related to the experimental request;
determine a plurality of sequence schedules for completing the set of instructions;
receive an indication of a sequence schedule selected from the plurality of sequence schedules; and
transmit one or more commands to execute the set of instructions according to the selected sequence schedule.

9. The system of claim 8, wherein the instructions, when executed by the one or more processors, further cause the system to:
collect information associated with executing the set of instructions according to the selected sequence schedule; and
transmit the collected information in response to the experimental request.

10. The system of claim 8, wherein, the instructions that cause the system to determine the plurality of sequence schedules further comprise instructions that cause the system to determine the plurality of sequence schedules based at least in part upon one or more available devices, one or more available materials, one or more estimated durations of executing the set of instructions, and one or more optimizations.

11. The system of claim 8, wherein, the instructions that cause the system to transmit the one or more commands to execute the set of instructions further comprise instructions that cause the system to transmit, to one or more human operators, the one or more commands to execute the set of instructions according to the selected sequence schedule.

12. The system of claim 8, wherein, the instructions that cause the system to transmit the one or more commands to execute the set of instructions further comprise instructions that cause the system to transmit, to one or more robotic operators, the one or more commands to execute the set of instructions according to the selected sequence schedule.

13. The system of claim 8, wherein, the instructions that cause the system to transmit the one or more commands to execute the set of instructions further comprise instructions that cause the system to transmit, to one or more human operators and one or more robotic operators, the one or more commands to execute the set of instructions according to the selected sequence schedule.

14. The system of claim 9, wherein the collected information includes at least one selected from a group consisting of an environmental variable, a device status, a device feedback, and a human feedback.

15. A non-transitory computer-readable medium storing instructions for processing an experimental request, the instructions when executed by one or more processors of a computing device, cause the computing device to:
generate a set of instructions for performing one or more experiments related to the experimental request;
determine a plurality of sequence schedules for completing the set of instructions;
receive an indication of a sequence schedule selected from the plurality of sequence schedules; and
transmit one or more commands to execute the set of instructions according to the selected sequence schedule.

16. The non-transitory computer-readable medium of claim 15, wherein, the instructions when executed by the one or more processors further cause the computing device to:
collect information associated with executing the set of instructions according to the selected sequence schedule; and
transmit the collected information in response to the experimental request.

17. The non-transitory computer-readable medium of claim 15, wherein, the instructions when executed by the one or more processors that cause the computing device to determine the plurality of sequence schedules further cause the computing device to determine the plurality of sequence schedules based at least in part upon one or more available devices, one or more available materials, one or more estimated durations of executing the set of instructions, and one or more optimizations.

18. The non-transitory computer-readable medium of claim 15, wherein, the instructions when executed by the one or more processors that cause the computing device to transmit the one or more commands to execute the set of instructions further cause the computing device to transmit, to one or more human operators, the one or more commands to execute the set of instructions according to the selected sequence schedule.

19. The non-transitory computer-readable medium of claim 15, wherein, the instructions when executed by the one or more processors that cause the computing device to transmit the one or more commands to execute the set of instructions further cause the computing device to transmit, to one or more robotic operators, the one or more commands to execute the set of instructions according to the selected sequence schedule.

20. The non-transitory computer-readable medium of claim 15, wherein, the instructions when executed by the one or more processors that cause the computing device to transmit the one or more commands to execute the set of instructions further cause the computing device to transmit, to one or more human operators and one or more robotic operators, the one or more commands to execute the set of instructions according to the selected sequence schedule.
